(19) United States
(12) Patent Application Publication
(10) Pub. No.: US 2006/0279046 A1
(43) Pub. Date: Dec. 14, 2006

(54) Seal and system of sealing lips arranged in series

(75) Inventors: Rolf Vogt, Oftersheim (DE); Volker Urbanski, Rimbach (DE); Holger Sattler, Siedelsbrunn (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/447,493

(22) Filed: Jun. 6, 2006

(30) Foreign Application Priority Data
Jun. 9, 2005 (EP) EP 05012434.6

(51) Int. Cl. F16J 15/32

(52) U.S. Cl. 277/549

(57) ABSTRACT

A seal is provided comprising at least two sealing lips including a first sealing lip and a second sealing lip being arranged in series. A sealing system is provided which ensures a problem-free operation with a long service life at the same time. The seal is characterized in that the sealing lips are made of different materials. A system, which includes such a seal, is assigned to a rotatable shaft and at least two sealing lips seal off two spaces against each other.

This application claims the benefit of European Patent Application No. 05 012 434.6 filed Jun. 9, 2005 and hereby incorporated by reference herein.

The present invention relates to a seal, including at least two sealing lips, a first sealing lip and a second sealing lip being arranged in series. Moreover, the present invention relates to a system including such a seal, the seal being assigned to a rotatable shaft and at least two sealing lips sealing two spaces against each other.

### BACKGROUND INFORMATION

Seals and systems of the type mentioned in the preamble are known from the related art. A seal used for sealing two machine elements which are rotatable relative to each other is known in particular from DE 197 54 400 A1.

The typical function of a sealing lip is to seal against a medium such as air or a lubricant. The manufacture of sealing lips using an elastomer is known from the related art. However, this has the disadvantage that in specific applications elastomers are subject to considerable wear.

The wear increases with increased pressure applied to such a sealing lip. During operation, a sealing lip is often pressed with excessive force against a rotating component, e.g., a shaft, by the pressure of a medium. This causes the sealing lip to experience a high degree of abrasion, which may result in leakage even after a short time of operation.

### SUMMARY OF THE INVENTION

An object of the present invention is to create a sealing system which ensures problem-free operation and a long service life at the same time.

The present invention provides a seal comprising at least two sealing lips, a first sealing lip and a second sealing lip being situated in series characterized in that the sealing lips are made of different materials.

According to the present invention, by selecting suitable materials, different sealing lips may be assigned different functions. Furthermore, each sealing lip may be manufactured as a function of the demands made on it. To that end, different sealing lips may be provided which are decoupled from one another and have material properties making the sealing lip operation with minimum wear possible. This makes it possible to implement problem-free operation of a sealing system and a long service life at the same time.

The first sealing lip may be made of a material which is more wear-resistant than that of the second sealing lip. It is conceivable that the first sealing lip may be made of a harder and/or a more bending-resistant material than the second sealing lip. Such a concrete design is sensible when the first sealing lip faces a medium which is under high pressure and presses the first sealing lip against a moving component. The first sealing lip relieves the second sealing lip with respect to the pressure applied to it so that the second sealing lip may be made of a softer material. The second sealing lip may assume the function of reliably sealing minor leaks which have passed by the first sealing lip.

To this end, the first sealing lip may be made of polytetrafluoroethylene. A sealing lip made of polytetrafluoroethylene seals reliably and wears only to a very small degree. However, due to the relatively hard, grainy structure of polytetrafluoroethylene, this material conforms only imperfectly to the surface of a rotating component. This results in the fact that a pressurized medium cannot be sealed reliably, which in turn results in a creeping leak. Air, oil mist, or low-viscosity lubricants when used as pressurized media may very easily diffuse through capillaries or pores of polytetrafluoroethylene due to their low viscosity. The first sealing lip may be made of polytetrafluoroethylene, either completely or partially. It is conceivable here that a film made of polytetrafluoroethylene may be assigned to the sealing lip or such a film acts as a sealing lip.

The second sealing lip may be made of an elastomer. This design makes it advantageously possible to reliably seal micro-leaks which are produced by the first sealing lip made of polytetrafluoroethylene, i.e., the second seal produces a fine seal.

The second sealing lip made of an elastomer may be largely protected against too much pressure by the first sealing lip, so that the second sealing lip is pressed against a rotating component only to a minor degree. This ensures little wear on the second sealing lip and optimized sealing at the same time.

A third sealing lip may be positioned adjacent to the second sealing lip. The third sealing lip could be pressed against a rotating component by spring pressure. In such a system, the second sealing lip acts as a series lip which carries out a first fine sealing and the third sealing lip optimizes the fine seal as an additional seal.

The second and third sealing lips may be made of the same material. It is conceivable that the sealing lips are made of an elastomer. In this connection it may also be conceivable that the first and second sealing lips have a one-piece design, thereby making it advantageously possible to process the second and third sealing lips in only a few work steps.

The sealing lips may be aligned parallel to one another, at least in some sections. This concrete design allows easy joining of the individual components of a seal, since parallel surfaces may be bonded together particularly well.

The second sealing lip may be supported by a housing. The second sealing lip may be made of an elastomer which, due to its softness, is not inherently stable when pressure is applied. In particular in this connection it is conceivable that a sealing lip made of an elastomer may be turned up when too much pressure is applied. In order to counteract this, a housing could largely surround the second sealing lip or it could be embedded in the sealing lip or the sealing lip body. In addition to or instead of the housing, it is also conceivable to provide a support member which is embedded in the sealing lip body.

In this connection, the housing and/or the support member may have an L-shaped design. The L shape enables a particularly firm bond of the elastomer with the housing or the support member which may be made of metal. The elastomer may be glued to the housing and/or the support member or may be bonded via vulcanization.

The sealing lips and/or the housing may define at least one vent channel. A vent channel makes pressure relief of the second sealing lip possible in a particularly simple manner. A pressurized medium, which passes the first sealing lip, flows into a volume which is delimited by the second sealing lip. Without the vent channel, the pressurized medium would apply high pressure to the second sealing lip, thereby pressing it against a rotating component. However, by providing vent channels, the pressurized medium may escape, thereby effectively relieving the second sealing lip.

Furthermore, the present invention provides a system including a seal of the type described earlier, the seal being assigned to a rotatable shaft, and at least two sealing lips seal off two spaces against each other.

In order to avoid repetitions, reference is made to the comments about the seal as such with regard to inventive step.

The sealing lips may be in contact with the shaft under radial stress. It is conceivable that the sealing lips may be designed in such a way that they are under pre-stress which presses the sealing lips against the surface of the shaft, thereby increasing the sealing effect of the sealing lips. Different amounts of pre-stress or radial stress may be applied to the sealing lips. This design of the sealing lips in connection with the system is, of course, also applicable to the seal alone.

A first space may be subjected to a higher pressure than a second space and the first sealing lip may face the first space and may curve out in its direction. The second sealing lip may also curve out toward the first space. The first sealing lip acts as a restrictor and the second sealing lip is effectively protected against the effect of pressure from the first space.

There are different possibilities for embodying and refining the teaching of the present invention in an advantageous manner. Reference should be made to the following description of preferred exemplary embodiments of the present invention based on the drawings. In connection with the description of the preferred exemplary embodiments of the present invention based on the drawings, generally preferred variants and refinements of the teaching are also explained.

### BRIEF DESCRIPTION OF THE DRAWING

FIG. 1 shows a sealing system in which the second sealing lip is surrounded by an L-shaped housing,

FIG. 2 shows a sealing system which is situated in a bore hole of a housing,

FIG. 3 shows a sealing system in which the first sealing lip is clamped between two support members,

FIG. 4 shows a sealing system having a third sealing lip,

FIG. 5 shows a seal having a vent channel and a third sealing lip which is able to be pressed against a shaft by spring pressure,

FIG. 6 shows a sealing system including a vent channel which runs through an L-shaped housing, and

FIG. 7 shows a sealing system in which a support member is embedded in the bodies of the second and third sealing lips.

### DETAILED DESCRIPTION OF THE EXEMPLARY EMBODIMENTS

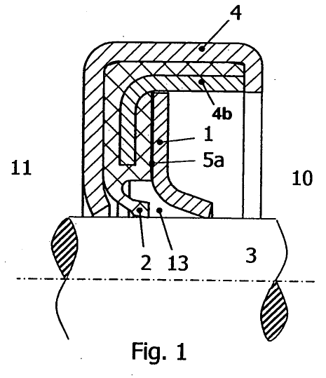

FIG. 1 shows a seal which includes at least two sealing lips 1 and 2. First sealing lip I and second sealing lip 2 are arranged in series. Sealing lips 1, 2 are made of different materials.

First sealing lip I is made of a more wear-resistant material then second sealing lip 2. First sealing lip 1 is made of polytetrafluoroethylene and second sealing lip 2 is made of an elastomer. The two sealing lips 1, 2 are situated adjacent to one another at an axial distance with respect to a shaft 3. Sealing lips 1, 2 both axially curve out toward a space to be sealed 10.

Sealing lip 2 is supported via a housing 4 which has an L-shaped design. Housing 4 surrounds the body from which sealing lip 2 is formed. At its ends housing 4 has flange-like bends in order to enclose the sealing lip body. An L-shaped support member 4b is embedded in the sealing lip body of sealing lip 2. This support member may be bonded by vulcanizing or gluing.

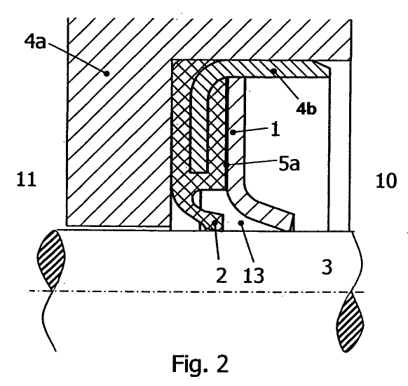

FIG. 2 shows a sealing system which is similarly configured as the sealing system in FIG. 1. The seal is accommodated in a bore hole of a housing 4a and supported directly by the bore hole wall. Housing 4a could be designed as an engine housing or a transmission housing.

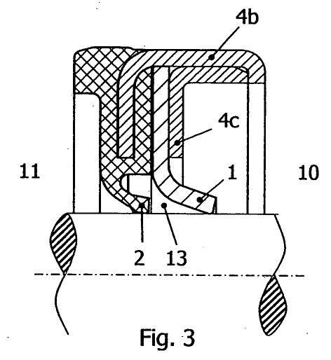

FIG. 3 shows a sealing system which is similarly configured as the sealing system in FIG. 1. However, first sealing lip 1 is not vulcanized or glued to the sealing lip body of sealing lip 2, but is rather pressed onto the sealing lip body of sealing lip 2 by support member 4c and support member 4b.

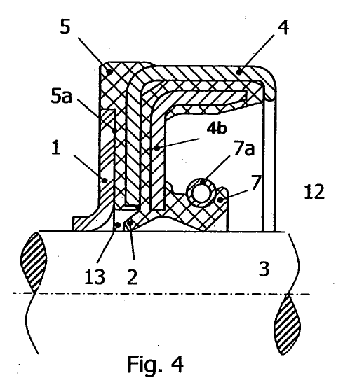

FIG. 4 shows a sealing system including a third sealing lip 7. Third sealing lip 7 is connected in series to the first two sealing lips 1 and 2. Second sealing lip 2 and third sealing lip 7 are made of the same material.

Third sealing lip 7 is pressed against shaft 3 by an annular spring 7a. Second sealing lip 2 acts as a series lip. The body, of which sealing lip 2 and sealing lip 7 are made, is inserted into housing 4. A separate connecting element 5 is vulcanized or glued between housing 4 and first sealing lip 1. Connecting element 5 is glued or vulcanized to sealing lip 1 as well as to housing 4. Separate connecting element 5 is bonded to first sealing lip 1 via a bonding area 5a; bonding area 5a may be designed as a vulcanization layer or an adhesive layer.

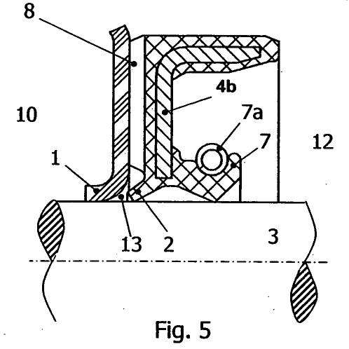

FIG. 5 shows a sealing system to which a vent channel 8 is assigned. Sealing lips 1 and 2 define vent channel 8. The pressurized medium may flow from space 10 into space 13 between sealing lip 1 and sealing lip 2 and from there into vent channel 8.

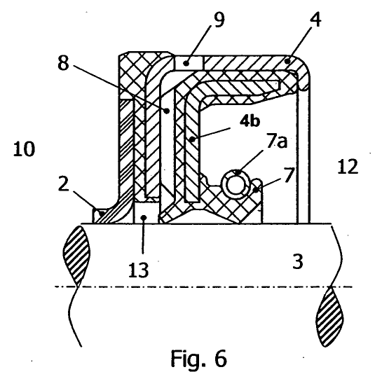

FIG. 6 shows a sealing system according to FIG. 5, bore holes 9 being provided in housing 4 which are flow-connected to vent channel 8 and space 13. Spaces 10 and 12 should be sealed off against each other.

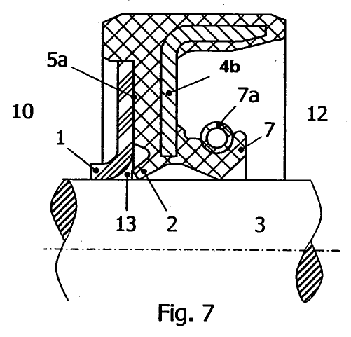

FIG. 7 shows a sealing system in which the seal shows a similar configuration as in FIG. 4. The body, of which sealing lips 2 and 7 are made, has a one-piece design and is bonded to first sealing lip 1 via bonding area 5a.

Sealing lips 1 and 2 are in contact with shaft 3 under radial stress. This configuration applies to all exemplary embodiments explained in FIGS. 1 through 7.

Reference should be made to the general portion of the description and to the appended patent claims with regard to further advantageous embodiments and refinements of the teaching according to the present invention. Finally, it should be explicitly pointed out that the purely arbitrarily selected exemplary embodiments are only used for discussing the teaching according to the present invention, but do not restrict same to these exemplary embodiments.

What is claimed is:

1. A seal comprising:
a first sealing lip; and
a second sealing lip;
the first and second sealing lips being situated in series;
the first and second sealing lips being made of different materials.

2. The seal as recited in claim 1 wherein the first sealing lip is made of a more wear-resistant material than the second sealing lip.

3. The seal as recited in claim 1 wherein the first sealing lip is made of polytetrafluoroethylene.

4. The seal as recited in claim 1 wherein the second sealing lip is made of an elastomer.

5. The seal as recited in claim 1 further comprising a third sealing lip situated adjacent to the second sealing lip.

6. The seal as recited in claim 5 wherein the second and third sealing lips are made of a same material.

7. The seal as recited in claim 1 wherein the first, second and a third sealing lip are aligned parallel to each other in at least some sections.

8. The seal as recited in claim 1 wherein the second sealing lip is supported by a housing or a support member.

9. The seal as recited in claim 8 wherein the housing or the support member has an L-shaped design.

10. The seal as recited in claim 8 wherein the first and second sealing lips or the housing define at least one vent channel.

11. A system comprising:
a seal including:
a first sealing lip; and
a second sealing lip;
the first and second sealing lips being situated in series;
the first and second sealing lips being made of different materials;
a rotable shaft assigned to the seal; and
the first and second sealing lips sealing off a first space from a second space.

12. The system as recited in claim 11 wherein the first, second and a third sealing lip are in contact with the shaft under radial stress.

13. The system as recited in claim 11 wherein the first space is subjected to a higher pressure than the second space, and the first sealing lip faces the first space and curves out in a direction of the first space.

14. The system as recited in claim 13 wherein the second sealing lip curves out toward the first space.
